(19) United States
(12) Patent Application Publication
(10) Pub. No.: US 2008/0013008 A1
(43) Pub. Date: Jan. 17, 2008

(54) Liquid Crystal Driving Circuit and Liquid Crystal Display Device with the Same

(75) Inventor: Takashi Akiyama, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: CITIZEN WATCH CO., LTD., Tokyo (JP)

(21) Appl. No.: 11/576,116

(22) PCT Filed: Sep. 28, 2005
(86) PCT No.: PCT/JP05/17810

§ 371 Date: Mar. 27, 2007

(30) Foreign Application Priority Data
Sep. 28, 2004 (JP) 2004-281014

(51) Int. Cl. G02F 1/136

(52) U.S. Cl. 349/41

(57) ABSTRACT

It is an object to reduce the cost and the power consumption in a circuit part for generating a gradation voltage of a liquid crystal driving circuit. A gradation voltage generating circuit (78) is provided with a gradation voltage generating part (88) for generating a plurality of gradation voltage for gradation display by a pixel of a liquid crystal display part; a source-follower connected transistor group (90) for performing impedance conversion on each of the plurality of gradation voltages; and an analog switch part (94) for selecting an output of the transistor group (90) and applying the output to a pixel group of a liquid crystal display part. Furthermore, the transistor group (90) is preferably provided with a current control circuit part (92) for controlling a current that flows in each transistor.

### TECHNICAL FIELD

The present invention relates to a liquid crystal driving circuit for driving a liquid crystal display part of a liquid crystal display device, particularly a gradation voltage generating circuit, and also to a liquid crystal display device with the liquid crystal driving circuit.

### BACKGROUND TECHNOLOGY

In recent years, a liquid crystal display device capable of color display by the TFT liquid crystal is increasingly used for portable equipment using a battery as its power supply, such as a cellular phone.

A problem with such equipment is the battery life and reduction in cost, and the gradation voltage generating circuit for gradation display by the liquid crystal part is a factor inhibiting the reduction in cost because of a large number of elements and has another problem of large power consumption.

Besides, a problem of difficulty of a reduction in power consumption in order to increase the battery life could not be solved in a color liquid crystal display device using a color filter because about ⅔ of light from the backlight is absorbed by the color filter.

Hence, a color liquid crystal display mode by a field sequential color (hereinafter, abbreviated to “FSC”) mode has been devised.

This technology is to perform color display by permitting a light source to sequentially emit a plurality of light with different wavelengths in a predetermined cycle, and applying driving voltages to the liquid crystal in synchronization with the light emission timings of the light source as described in Patent Document 1. Therefore, there are great advantages in that the power consumption is low because no color filter is required, and that high definition can be realized because a pixel does not need to be divided for each of colors of the color filter. Accordingly, the FSC mode is increasingly recognized as a driving mode of the color liquid crystal display device suitable for the portable equipment.

FIG. 13 is a chart for explaining a method of controlling the liquid crystal display device in the FSC mode.

In FIG. 13, tL shows one field period, and two field periods constitute one frame (displaying one screen). The frame frequency is commonly 30 Hz or more.

In the FSC mode, one field period tL is divided into sub-fields corresponding to the number of colors of light emitted by a backlight. The one field period tL is divided here into three sub-fields, that is, a red (R) subfield tR, a green (G) subfield tG, and a blue (B) subfield tB, the colors being three primary colors.

In the normal driving mode using a color filter, a white backlight is turned ON throughout the one field period tL as shown at an “NML white” in FIG. 13.

In contrast to the above, in the FSC mode, data for red is displayed on the liquid crystal display part during the red (R) subfield tR, the data being displayed by turning ON the red backlight “R”. During the green (G) subfield tG, data for green is displayed on the liquid crystal display part, the data being displayed by turning ON the green backlight “G”. Further, during the blue (B) subfield tB, data for blue is displayed on the liquid crystal display part, the data being displayed by turning ON the blue backlight “B”. These pieces of display information in three primary colors are integrated by a human eye so that the display is recognized. A plurality of color light are sequentially and repeatedly emitted for display as described above.

However, there is a very substantial need for a reduction in power consumption of the cellular phone and the like, and it is not enough to employ the FSC mode for the reduction in power consumption. Besides, a further cost reduction by reducing the number of elements in the liquid crystal control system is desired.

For the reduction in cost by reducing the number of elements in the liquid crystal control system, there is a proposal, for example, as disclosed in Patent Document 2. According to the proposal, one of a plurality of gradation voltages is selected by a selector provided for each of data electrode lines of the liquid crystal display device, and the selected gradation voltage is sent to a comparator which is also provided for each of the data electrode lines of the liquid crystal display device. The comparator compares a ramp voltage which is provided in common to the above-described selected gradation voltage, and when they coincide with each other, the voltage is stored in a sampling capacitor provided for each of the data electrode lines of the liquid crystal display device. The voltage stored in the sampling capacitor is sent to the liquid crystal display device via a source follower circuit provided for each of the data electrode lines of the liquid crystal display device.

This technology is to reduce the number of elements of a portion for selecting the plurality of gradation voltages to thereby reduce the size of an IC for driving the liquid crystal display device, but the disclosure does not refer to a portion for generating the plurality of gradation voltages nor a technology to reduce the power consumption. For example, constant current sources Ia, Ib, . . . In shown in FIG. 1 of Patent Document 2 are configured to constantly feed current.

Besides, as disclosed in Patent Document 3, there is another proposal in which one of a plurality of gradation voltages is selected by a selector provided for each of data electrode lines of the liquid crystal display device, and the selected gradation voltage is stored in a sampling capacitor provided for each of the data electrode lines of the liquid crystal display device, and the voltage stored in the sampling capacitor is reduced in impedance by a source follower circuit provided for each of the data electrode lines of the liquid crystal display device and sent to the liquid crystal display device.

This technology is also to reduce the number of elements of a portion for selecting the plurality of gradation voltages to thereby reduce the size of an IC for driving the liquid crystal display device, and a source follower circuit is provided for each of the data electrode lines of the liquid crystal display device to reduce the impedance.

However, in the case of using the source follower circuit for an output driver, it is necessary to connect the substrate potential of MOSFET to the output terminal when the circuit is integrated in an IC which is different in substrate potential from other elements. Therefore, the power supply of the element is separated in order to separate the substrate potential in the IC, thus actually causing little or no effect on reduction in size as compared to the conventional output circuit.

In addition, it is unnecessary to reduce so much impedance in a medium- and small-sized liquid crystal display devices, and the proportion of increase in area of the element for separation of the substrate potential is large that is larger than in a conventional one. Therefore, this technology makes nothing for reduction in size of the IC for driving the medium- and small-sized liquid crystal display devices.

Further, this disclosure does not refer to a portion for generating the plurality of gradation voltages nor a technology to reduce the power consumption, as in the above-described example. This is clear also from the configuration in which current is constantly fed to a group of constant current transistors 151, 152, and 15k in FIG. 1 of Patent Document 3.

Patent Document 1: JP H5-19257 A
Patent Document 2: JP 2600372 B
Patent Document 3: JP H7-38104 B

### DISCLOSURE OF THE INVENTION

### Problems to be Solved by the Invention

As described above, a large number of elements are still used in a circuit portion for generating gradation voltages in a conventionally proposed driving circuit for the liquid crystal display device, thus failing to achieve the required cost reduction. It is also impossible to sufficiently reduce the power consumption.

The invention has been developed in consideration of such circumstances, and it is an object to further reduce the cost and the power consumption of the liquid crystal driving circuit and the liquid crystal display device with the circuit.

### Means to Solve the Problem

The liquid crystal driving circuit according to the invention is a liquid crystal driving circuit for a liquid crystal display device including a liquid crystal display part having a transistor for each individual pixel; a group of selection signal lines each provided for each row of the liquid crystal display part and connected to a gate electrode of the transistor for selecting a row of the liquid crystal display part; and a group of data electrode lines each provided for each column of the liquid crystal display part and connected to a source electrode of the transistor for supplying voltage data for controlling a display state of each pixel of the liquid crystal display part, which is configured as follows in order to achieve the above object.

Namely, a gradation voltage generating circuit is provided for generating a plurality of voltages for gradation display by the liquid crystal display part, the gradation voltage generating circuit including a gradation voltage generating part for generating a plurality of gradation voltages for gradation display by the pixels of the liquid crystal display part, a source-follower connected transistor group for performing impedance conversion on each of the plurality of gradation voltages, and an analogue switch part for selecting an output of the transistor group and applying the output to the data electrode line group.

Further, it is preferable that each transistor of the source-follower connected transistor group is provided with a current control circuit. It is more preferable that the current control circuit includes a resistor element.

Alternatively, it is more preferable that the current control circuit includes at least a set of a resistor element and a switching element connected in series.

It is also possible that a current to be fed through the current control circuit is made variable.

Further, it is desirable that the current to be fed through the current control circuit is set larger during a selection period to write data into the liquid crystal display device than during a non-selection period during which data writing into the liquid crystal display device is stopped.

Further, the liquid crystal driving circuit is suitable for driving the liquid crystal display device including a light source for sequentially and repeatedly emitting a plurality of color light and a liquid crystal display part for controlling transmission of the light emitted by the light source, in which one field is divided into a plurality of sub-fields, specific color light of the plurality of color light is emitted during at least a portion of period of the plurality of sub-fields, and an image corresponding to the specific color light is displayed on the liquid crystal display part to perform color display.

The liquid crystal display device according to the invention is a liquid crystal display device including a liquid crystal display part having a transistor for each individual pixel; a group of selection signal lines each provided for each row of the liquid crystal display part and connected to a gate electrode of the transistor for selecting a row of the liquid crystal display part; and a group of data electrode lines each provided for each column of the liquid crystal display part and connected to a source electrode of the transistor for supplying voltage data for controlling a display state of each pixel of the liquid crystal display part, including the above-described liquid crystal driving circuit, wherein the liquid crystal display part is driven by the liquid crystal driving circuit.

### Effect of the Invention

According to the invention, the number of elements of the gradation voltage generating circuit in the liquid crystal driving circuit can be reduced to significantly reduce the power consumption, and the area of the integrated circuit constituting the gradation voltage generating circuit can be reduced to also reduce the cost. Further, by providing the current control circuit, a stable gradation voltage can be supplied to the liquid crystal display part to improve the display quality and realize the reduction in current.

### BRIEF DESCRIPTION OF DRAWINGS

FIG. 1 is a block diagram showing an embodiment of a liquid crystal driving circuit according to the invention;

FIG. 2 is a schematic cross-sectional view showing an example of a panel part in the liquid crystal display device in the FSC mode driven by the liquid crystal driving circuit according to the invention;

FIG. 3 is a similar schematic cross-sectional view showing another example of the panel part in the liquid crystal display device;

FIG. 4 is a similar schematic cross-sectional view showing still another example of the panel part in the liquid crystal display device;

FIG. 5 is an enlarged plan view of an internal reflecting film in FIG. 4 for one pixel;

FIG. 6 is a schematic cross-sectional view showing a portion of the liquid crystal display part shown in FIG. 2 to FIG. 4 enlarged;

FIG. 7 is a view showing a selection signal line group and a data electrode line group and equivalent circuits of pixels formed on the liquid crystal display part shown in FIG. 2 to FIG. 4;

FIG. 8 is a circuit diagram showing a concrete example of the gradation voltage generating circuit in the liquid crystal driving circuit shown in FIG. 1;

FIG. 9 is a circuit diagram showing a concrete example of the current control circuit in FIG. 8;

FIG. 10 is a circuit diagram showing another concrete example of the current control circuit in FIG. 8;

FIG. 11 is a circuit concretely showing one of switch parts of an analogue switch part in FIG. 8;

FIG. 12 is a timing chart for explaining a method of controlling the liquid crystal display device in the FSC mode according to the invention; and

FIG. 13 is a chart for explaining a method of controlling the liquid crystal display device in the FSC mode.

### REFERENCE OF NUMERALS

10 liquid crystal display part
12 polarizing plate
13 display electrode (pixel electrode)
14 upper transparent substrate
15 sealing material

16 liquid crystal layer
17 common electrode
18 lower transparent substrate
20 polarizing plate
21 backlight unit
22 light guide plate
24 light source
26 transflective reflecting plate
28 reflecting layer
30 internal reflecting layer (also serving as common electrode)
32 light transmission part
42 thin film transistor (TFT)
43 pixel region
44 capacitor (storage capacitance)
46 capacitor (pixel capacitance)

48 data electrode line group
50 selection signal line group
70 image memory
78 gradation voltage generating circuit
88 gradation voltage generating part
90 source-follower connected transistor group
92 current control circuit part
94 analogue switch part
twr write period
twa response waiting period
tli lighting period
I1, I2, I3, . . . , I8 current control circuit
twr selection period twa,
tli non-selection period

### BEST MODE FOR CARRYING OUT THE INVENTION

Hereinafter, embodiments of the invention will be described with reference to the accompanying drawings.

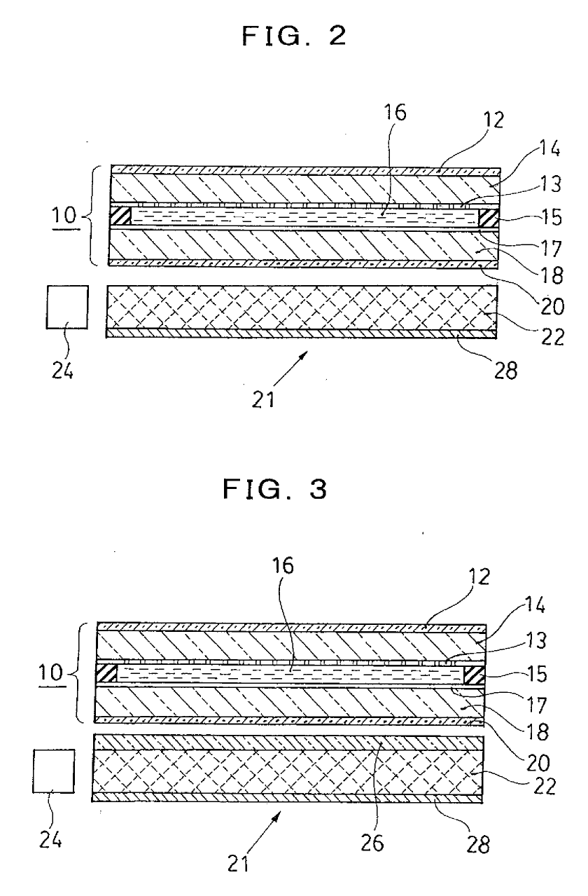

First, a configuration example of a panel part of a liquid crystal display device in the FSC drive mode driven by a liquid crystal driving circuit according to the invention will be described with reference to FIG. 2 to FIG. 7.

FIG. 2 is a schematic cross-sectional view showing an example of the panel part of the liquid crystal display device.

In FIG. 2, an upper transparent substrate 14 and a lower transparent substrate 18 each made of transparent glass or resin are bonded together with a sealing material 15 with a predetermined space intervening therebetween, a liquid crystal layer 16 is sealed and held in the space, and a polarizing plate 12 and a polarizing plate 20 are bonded to an upper surface of the upper transparent substrate 14 and a lower surface of the lower transparent substrate 18, respectively, to form a liquid crystal display part 10.

On an inner surface of the upper transparent substrate 14 (surface on the liquid crystal layer 16 side), a display electrode (pixel electrode) 13 and a thin film transistor (TFT) for each pixel region, a selection signal line group and a data electrode line group which are not shown in FIG. 2 are provided. Those details will be described later. On an inner surface of the lower transparent substrate 18 (surface on the liquid crystal layer 16 side), a common electrode 17 is formed on the entire surface. Each of the display electrode 13 and the common electrode 17 is a transparent conductive film such as indium tin oxide (ITO).

Portions where the display electrodes 13 and the common electrode 17 are opposed constitute pixels in a dot matrix form. Note that on the surface of each of the display electrodes 13 and the common electrode 17, an alignment film is formed for aligning molecules of the liquid crystal layer 16 in a fixed direction, but illustration thereof is omitted.

The liquid crystal layer 16, which comprises, for example, a twisted nematic (TN) liquid crystal, has optical rotatory power where no voltage is applied between the display electrode 13 and the common electrode 17 to rotate the polarization direction of the linearly polarized light transmitted through the liquid crystal layer 16 by 90°, while losing the optical rotatory power where a predetermined voltage is applied between the display electrode 13 and the common electrode 17 to transmit the linearly polarized light as it is.

Each of the polarizing plate 12 and the polarizing plate 20 is a typical absorption-type polarizing plate that transmits a linearly polarized light with a polarization direction parallel to the transmission axis and absorbs a linearly polarized light with a polarization direction orthogonal to the transmission axis, and the polarizing plates 12 and 20 are arranged such that their transmission axes are orthogonal or parallel to each other.

Therefore, the transmittance of each pixel changes depending on the presence or absence and the magnitude of a voltage to be applied between the display electrode 13 and the common electrode 17 to function as a shutter. Note that a super twisted nematic (STN) liquid crystal or a ferroelectric liquid crystal can also be used as the liquid crystal layer 16.

Under the lower transparent substrate 18 of the liquid crystal display part 10, a backlight unit 21 is provided which is composed of a light source 24 capable of sequentially and repeatedly emitting light of a plurality of colors with different wavelengths, for example, red, green, and blue light; a light guide plate 22 for planarly diffusing the light emitted by the light source 24; and a reflecting layer 28 provided under the light guide plate 22.

The liquid crystal display part 10 of the liquid crystal display device in the FSC driving mode is not provided with a color filter Therefore, it is not necessary to divide each pixel into regions where color filters of three primary colors are arranged.

In the liquid crystal display device configured as described above, at the time when performing the FSC drive, the backlight unit 21 sequentially emits light of three primary colors to illuminate the liquid crystal display part 10, and the liquid crystal display part 10 functions as a shutter for each pixel according to display data corresponding to each color, thereby performing color display.

Further, the liquid crystal display device can be used also as a reflection-type black-and-white display device using external light by stopping the light emission by the light source 24 of the backlight unit 21.

Besides, the liquid crystal display device functions as a transmission-type monocolor display device by permitting the light source 24 of the backlight unit 21 to emit light of only one color and binary-driving each pixel of the liquid crystal display part 10.

FIG. 3 is a schematic cross-sectional view showing another example of the panel part of the liquid crystal display device driven by the liquid crystal driving circuit according to the invention, in which the same numerals are given to the same portions as those in FIG. 2, and their description will be omitted.

A different point of the liquid crystal display device shown in FIG. 3 from the liquid crystal display panel shown in FIG. 2 is that a transflective reflecting plate 26 is provided between the lower transparent substrate 18 of the liquid crystal display part 10 and the light guide plate 22 of the backlight unit 21.

Thus, at the time when performing the FSC drive, the backlight unit 21 sequentially emits light of three primary colors, of which the light transmitted through the transflective reflecting plate 26 illuminates the liquid crystal display part 10. During the black-and-white display, a portion of the light incident on the liquid crystal display part 10 from the viewing side and transmitted therethrough and reached the transflective reflecting plate 26 is reflected and returned to the viewing side above the upper transparent substrate 14.

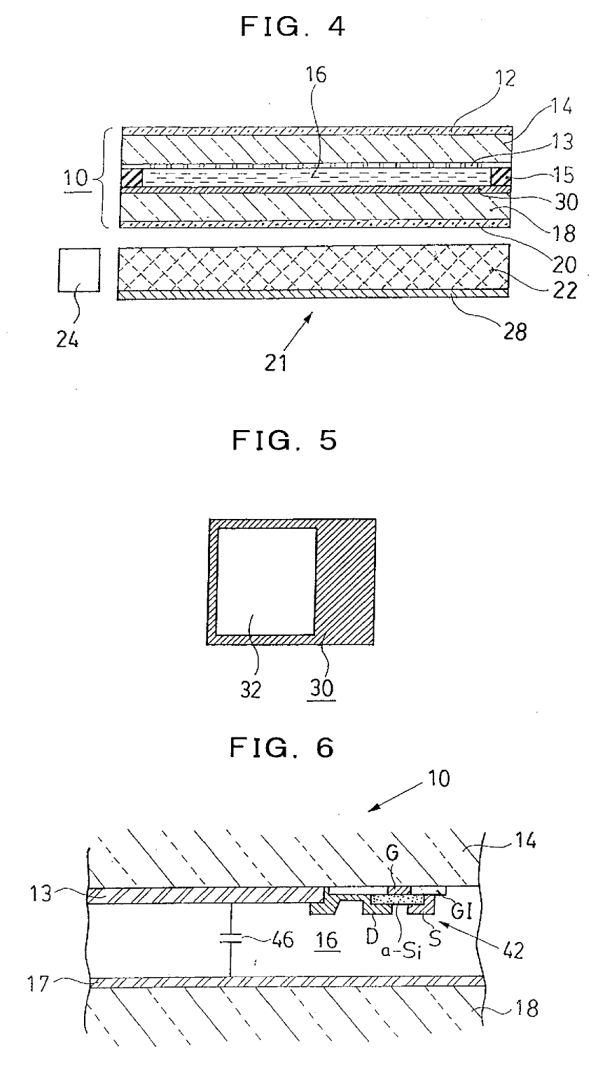

FIG. 4 is a schematic cross-sectional view showing still another example of the panel part of the liquid crystal display device driven by the liquid crystal driving circuit according to the invention, in which also the same numerals are given here to the same portions as those in FIG. 2, and their description will be omitted.

A different point of the liquid crystal display device shown in FIG. 4 from the liquid crystal display device shown in FIG. 2 is that an internal reflecting layer 30 is provided on the lower transparent substrate 18 of the liquid crystal display part 10.

In the internal reflecting layer 30, a light transmission part 32 is formed by hollowing a portion of the internal reflecting layer 30 for each pixel as shown in FIG. 5. The internal reflecting layer 30 can also serve as the previously-described common electrode 17 if the internal reflecting layer 30 is a conductive reflecting film such as an aluminum thin film or the like. In this case, a transparent conductive film is preferably formed in the light transmission part 32. Alternatively, the common electrode may be formed of a transparent conductive film over the entire region of the internal reflecting layer 30 also including the light transmission part 32.

In the liquid crystal display device, at the time when performing the FSC drive, the backlight unit 21 sequentially emits light of three primary colors, the backlight illuminates the liquid crystal display part 10, of which the light transmitted through the light transmission part 32 of the internal reflecting layer 30 goes out to the viewing side.

During the black-and-white display, external light incident on the liquid crystal display part 10 from the viewing side is reflected by the internal reflecting layer 30 and returned to the viewing side, thereby performing the black-and-white display.

Note that the internal reflecting layer 30 can be formed concurrently with the formation of a later-described electrode group of TFTs, thus bringing about cost effect.

The display electrode and the thin film transistor (TFT) provided for each pixel in the liquid crystal display parts 10 of the liquid crystal display devices shown in FIG. 2 to FIG. 4 will be described now using FIG. 6. FIG. 6 is a schematic cross-sectional view showing a portion of the liquid crystal display part enlarged.

As shown in FIG. 6, the display electrode 13 made of a transparent conductive film is formed for each pixel region on the inner surface of the upper transparent substrate 14, and a TFT 42 is formed adjacent thereto.

Further, a region where the display electrode 13 and the common electrode 17 (the internal reflecting layer 30 in the example in FIG. 4) are opposed to each other with the liquid crystal layer 16 intervening therebetween constitutes a pixel, where a pixel capacitance using the liquid crystal layer 16 as a dielectric exists which is shown by a capacitor 46.

The TFT 42 is composed of a gate electrode G and a gate insulating film GI formed on the upper transparent substrate 14, an amorphous silicon a-Si, and a source electrode S and a drain electrode D formed thereon, the drain electrode D being connected to the display electrode 13.

Further, a storage capacitance using the gate insulating film GI as a dielectric is formed between the upper transparent substrate 14 and a portion of the display electrode 13 and is connected in parallel with the capacitor 46, but this is a well known technology and therefore illustration thereof is omitted here.

Note that the display electrode 13 and the TFT 42 may be formed on the lower transparent substrate 18, and the common electrode 17 may be formed on the upper transparent substrate 14.

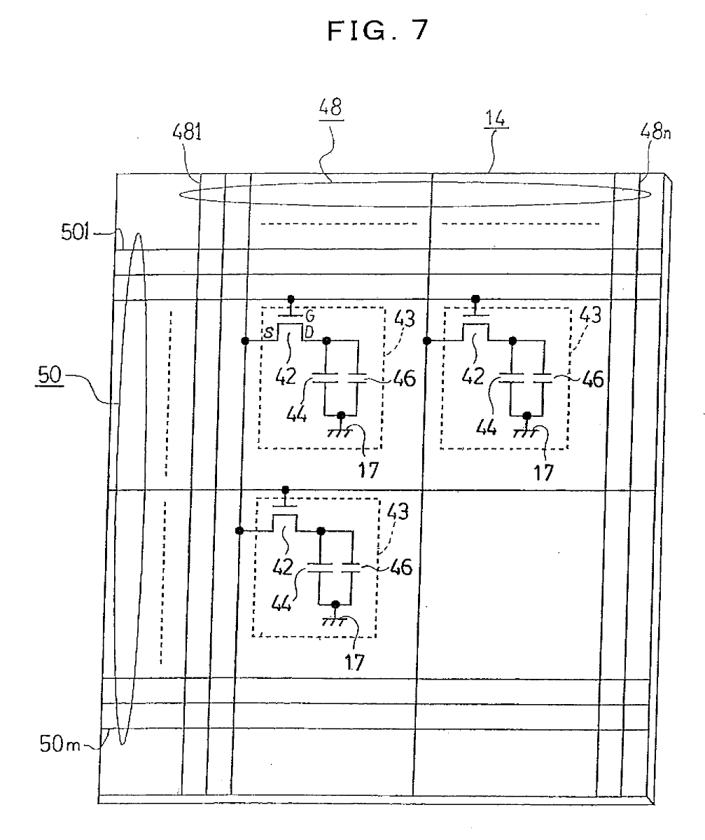

Next, a selection signal line group and a data electrode line group and equivalent circuits of pixels formed on the upper transparent substrate 14 of the liquid crystal display part will be described using FIG. 7.

In FIG. 7, on the upper transparent substrate 14, a selection signal line group 50 composed of selection signal lines (scanning electrodes) 50l to 50m and a data electrode line group 48 composed of data electrode lines (data signal lines) 48l to 48n are formed perpendicular to each other such as to partition the matrix of pixel regions 43 shown by broken lines.

The above-described TFT 42 is provided for each pixel region 43, and its drain electrode D is connected to the above-described display electrode 13, its source electrode S is connected to one line of the data electrode line group 48, and its gate electrode G is connected to one line of the selection signal line group 50, respectively. The capacitor 46 being the pixel capacitance shown in FIG. 6 and a capacitor 44 being the previously described storage capacitance are equivalently connected in parallel to form a signal holding capacitance of each pixel, and its one end is connected to the drain electrode D of the TFT 42 and the other end is connected to the common electrode 17 (the internal reflecting layer 30 in the example in FIG. 4) to be supplied with the ground potential.

The gate electrode G of the TFT 42 is connected to one line of the selection signal line group 50 for each row, so that the TFTs 42 in each row are sequentially scanned, that is, selected, whereby the selected TFT 42 is brought into a conduction state to capture display data on one line of the data electrode line group 48 connected to the source electrode S, into the capacitors 44 and 46. The liquid crystal layer 16 of each pixel region 43 is driven according to the voltage captured into the capacitors 44 and 46.

The gate electrodes G of the respective TFTs 42 of a plurality of pixel regions 43 in one row are connected to the same one line of the selection signal line group 50, so that the display information is written into the respective capacitors 44 and 46 by each of the TFTs 42, and the display information (voltage) is held by the capacitors 44 and 46. Thus, the liquid crystal display part can hold the display state for at least a certain time when the data is written into the pixel.

In the normal drive in the liquid crystal display device using a color filter, the period from the time when the first selection signal line 50l is selected to the time when that line is selected next is one field, and in the FSC drive, the first selection signal line 50l is selected the number of times corresponding to the number of colors of emitted light by the light source (three times here) in one field.

Though not shown, a driving IC may be COG-mounted on the upper transparent substrate 14, or a driving IC mounted on a film may be connected to the data electrode line group 48 and the selection signal line group 50.

Note that it is a matter in design to use the liquid crystal display part shown in FIG. 7 rotated by 90 degrees or 270 degrees. In those cases, rows (selection signal lines) are lines in the vertical direction and columns (data electrode lines) are lines in the horizontal direction.

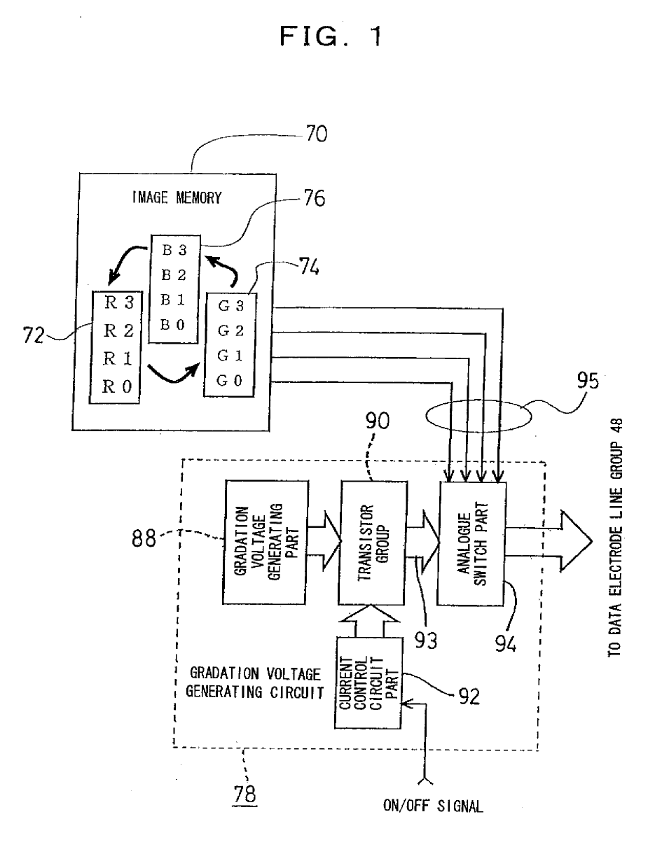

FIG. 1 is a block diagram showing an embodiment of the liquid crystal driving circuit according to the invention.

In FIG. 1, a gradation voltage generating circuit 78 comprises a gradation voltage generating part 88 for generating a plurality of gradation voltages for gradation display by pixels in the above-described liquid crystal display part 10; a source-follower connected transistor group 90 for performing impedance conversion of each of the plurality of gradation voltages; and an analogue switch part 94 for selecting an output of the transistor group 90 and applying it to the data electrode line group 48 shown in FIG. 7.

The gradation voltage generating part 88 generates gradation voltage signals corresponding to the number of gradations displayed by the liquid crystal display part, and the transistor group 90 reduces the impedance of the gradation voltage signal group and outputs it to a bus line 93. An example is shown here in which the gradation voltage signal to each pixel is composed of four bits.

An image memory 70 has a red data memory 72, a green data memory 74, and a blue data memory 76 each for storing 4-bit display data for each color, and sequentially sends the display data for each color, each row, and each pixel to the analogue switch part 94 in synchronization with a later-described write period of a subfield period of each color.

The analogue switch part 94 selects a gradation voltage signal from the bus line 93 according to display data 95 sent from the image memory 70 and sends it to the data electrode line group 48 in FIG. 7.

Further, to each transistor of the transistor group 90 for reducing the impedance of the gradation voltage signal group, a current control circuit is connected by a current control circuit part 92.

The current control circuit part 92 is provided to reduce the range of the gradation voltage signal having reduced impedance varying due to a load variation. The current control circuit part 92 is brought into a conduction state by an ON/OFF signal during the period when the gradation voltage is being written into each pixel of the liquid crystal display part via the analog switch part 94, and is brought into a non-conduction state during the other period to reduce the power conduction.

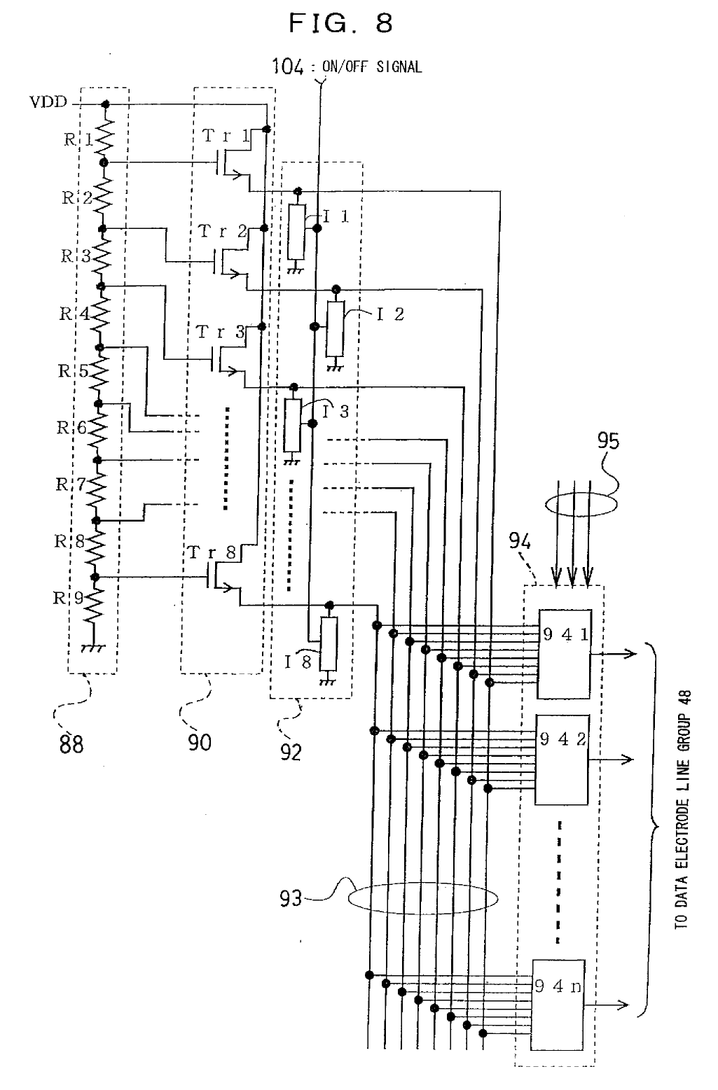

FIG. 8 is a circuit diagram showing a concrete example of the gradation voltage generating part 88 in the liquid crystal driving circuit shown in FIG. 1, showing an example of outputting gradation voltages of eight gradations.

In FIG. 8, the gradation voltage generating part 88 is composed of nine resistors R1 to R9 connected in series between a power supply potential VDD and the earth potential GND, and the resistance values of the respective resistors are set so that the gradation voltages for use in the gradation display can be obtained from the connection points between the respective resistors.

The eight kinds of voltages for eight gradations generated in the gradation generating part 88 are sent to the transistor group 90.

Note that the configuration for generating the eight kinds of voltages may be made using eight resistors or seven resistors. Further, switches may be provided in series with the resistors R1 to R9 and configured so as not to flow the current except for the later-described write period in order to reduce the power consumption.

The transistor group 90 is composed of source-follower connected transistors Tr1 to Tr8, each of which having a drain electrode connected to VDD, a gate electrode to which the gradation voltage is applied, and a source electrode as the output line. Although the gradation voltages to be applied to gate electrodes of the source-follower connected transistors Tr1 to Tr8 have relatively high impedances, gradation voltages having reduced impedances are obtained from the source electrodes of the transistors Tr1 to Tr8 being the output lines of the transistor group 90.

Conventionally, operation amplifiers have been used as elements for impedance conversion, but the source-follower connected transistors are used in the invention so that the number of elements can be substantially reduced. Though the embodiment shown in FIG. 8 is illustrated in an example in which gradation voltages of eight gradations are generated for the sake of simplicity, such effect is profound if the number of gradations is large, such as 256 gradations or 512 gradations.

Note that since the output voltage of the gradation voltage generating part 88 drops in each of the source-follower connected transistors Tr1 to Tr8 by an amount of a threshold voltage (hereinafter, abbreviated to “Vth”) of that transistor, the resistance value of each of the resistors R1 to R9 is set such that the output voltage of the gradation voltage generating part 88 is higher by that threshold voltage Vth.

To each of the output lines of the transistor group 90, each of the current control circuits I1 to I8 of the current control circuit part 92 is connected, and each of the output lines is connected to the bus line 93 of gradation voltage.

The current control circuits I1 to I8 are provided to prevent variation in the gradation voltages on the bus line 93 due to overload, and a bleeder current is fed along a path of VDD, Trn, In, and GND in that order to prevent variation in the gradation voltage while the gradation voltage is written from the bus line 93 into each pixel of the liquid crystal display part 10. This allows for supply of a stable gradation voltage into the liquid crystal display part 10, resulting in improved display quality.

Further, the current control circuits I1 to I8 are configured to be able to turn ON/OFF the bleeder current by an ON/OFF signal, and are turned ON while the gradation voltage is written into each pixel of the liquid crystal display part 10 and turned OFF during the other period. The current control circuits I1 to I8 are intermittently turned ON as described above, whereby a reduction in current can be realized with the display quality maintained.

In the analogue switch part 94, switch parts 94l to 94n corresponding to the number of the data electrode lines 48l to 48n shown in FIG. 7 are provided to select a gradation voltage from the bus line 93 of gradation voltage in response to the display data 95 sent from the image memory 70 shown in FIG. 1 and send it to the data electrode line group 48 of the liquid crystal display part 10.

In the configuration as in FIG. 8, only a set of transistor group 90 needs separation of substrate potential and requires a large area when integrated in an IC, and the switch parts 94l to 94n of the analogue switch part 94 having a relatively small area when integrated in an IC corresponding to the number of the data electrode lines 48l to 48n shown in FIG. 7 of the liquid crystal display part 10 can be used to construct the gradation voltage generating circuit 78 shown in FIG. 1.

Thus, an integrated circuit for a liquid crystal driving circuit according to the invention in which the gradation voltage generating circuit is provided can be reduced in area and cost. This effect is clear when compared with, for example, the technology disclosed in Patent Document 3. The liquid crystal driving circuit described in Patent Document 3 requires source-follower connected transistors requiring a large area, corresponding to the number of data electrode lines constituting the data electrode line group 48 of the liquid crystal display part.

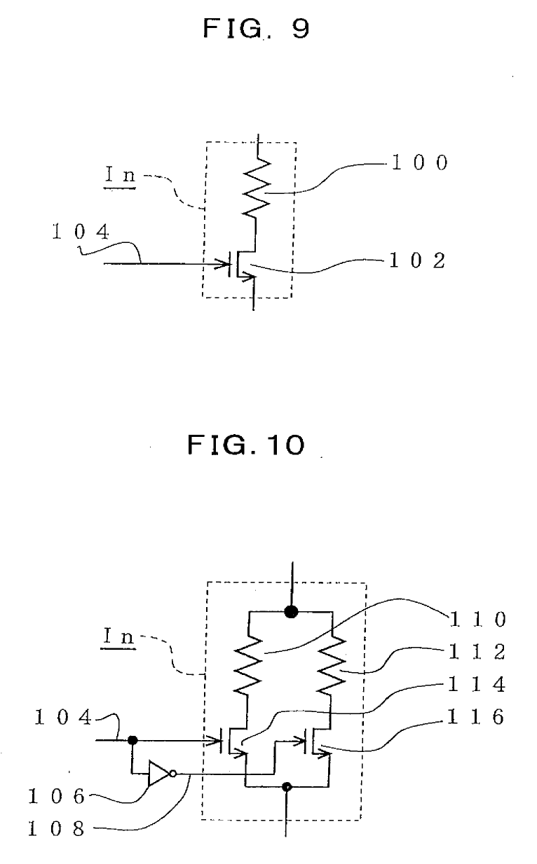

FIG. 9 is a circuit diagram showing a concrete example of the current control circuits I1 to I8 (In in the diagram) in FIG. 8. The current control circuit In comprises a set of a resistor element 100 and a switching element 102 connected in series.

FIG. 10 is a similar circuit diagram showing another concrete example of the current control circuits I1 to I8 (In in the diagram). The current control circuit In comprises two sets of resistor elements 110 and 112 and switching elements 114 and 116 connected in series respectively.

In these current control circuits In, conduction/non-conduction of the switching elements 102 and 114 is controlled, for example, by the ON/OFF signal 104 shown in FIG. 8, and conduction/non-conduction of the switching element 116 is controlled, for example, by a signal 108 created by inverting the ON/OFF signal 104 shown in FIG. 8 by the inverter 106.

As described above, each of the current control circuits In constituting the current control circuit part 92 shown in FIG. 8 has a resistor element, and has at least one set of the resistor element and switching element connected in series.

The configuration of each of the current control circuits In as described above ensures that, in the case of the configuration in FIG. 9, the switching element 102 is brought into a conduction state during a selection period to write data into the liquid crystal display device to flow a relatively large current via the resistor element 100 having a relatively low resistance value, thereby stabilizing the output voltage of each of the source-follower connected transistors Tr1 to Tr8 shown in FIG. 7 against load variation.

The switching element 102 is brought into a non-conduction state during most of a non-selection period during which data writing into the liquid crystal display device is stopped, to bring the current flowing through the source follower-connected transistors Tr1 to Tr8 shown in FIG. 8 to almost zero, thereby reducing the power consumption.

In the case of the configuration in FIG. 10, the switching element 114 is brought into a conduction state during the selection period to flow a relatively large current via the resistor element 110 having a relatively low resistance value, thereby stabilizing the output voltage of each of the source-follower connected transistors Tr1 to Tr8 shown in FIG. 8 against load variation, and the switching element 114 is brought into a non-conduction state and the switching element 116 is brought into a conduction state during most of the non-selection period to flow a relatively small current via the resistor element 112 having a relatively high resistance value, thereby stabilizing the output voltage of each of the source-follower connected transistors Tr1 to Tr8 also during no load as well as reducing the power consumption.

The current to be fed through the current control circuit In is made variable as described above in the liquid crystal driving circuit in this embodiment, whereby the current fed through the current control circuit In can be set larger during the selection period than during most of the non-selection period during which the data writing into the liquid crystal display device is stopped.

Note that the current control circuit may be composed of only the resistor element(s) for a reduction in size of the driving circuit.

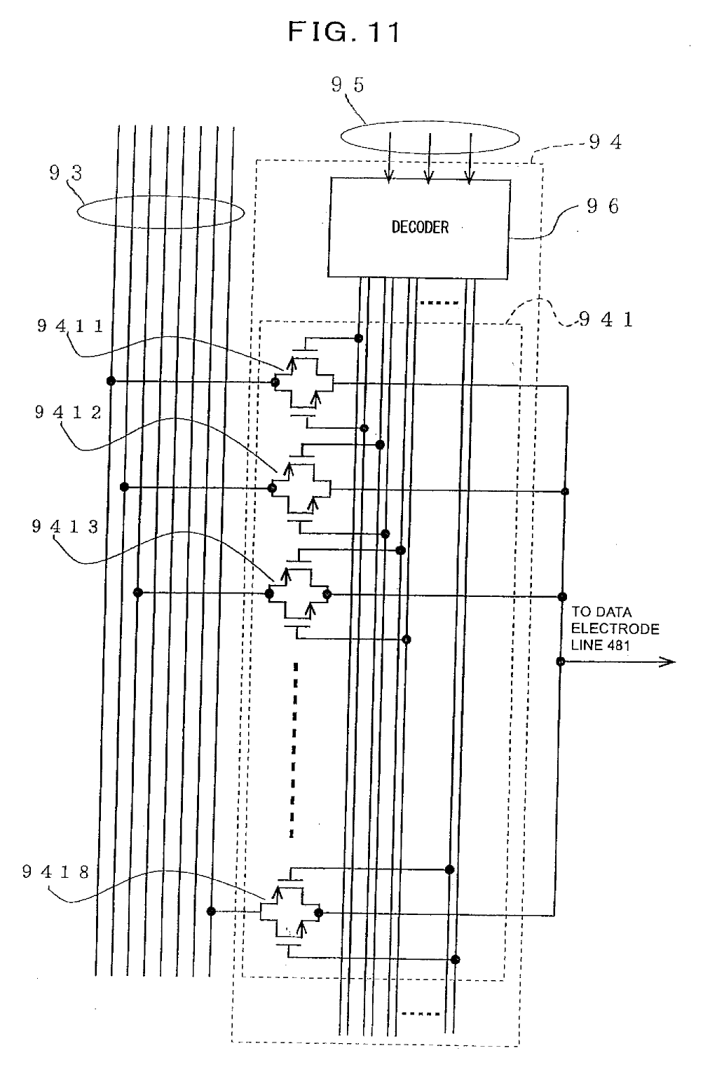

FIG. 11 is a circuit concretely showing one of the switch parts of the analogue switch part 94 in FIG. 8.

In FIG. 11, one switch part of the analogue switch part 94 shown in FIG. 8, for example, the switch part 941 is composed of analogue switches 9411 to 9418, in each of which a P-channel transistor and an N-channel transistor are connected in parallel, which are connected to different lines of the bus line 93 of gradation voltage, respectively, and their outputs are in wired-OR connection and connected to the data electrode line 48l shown in FIG. 7.

The display data 95 sent from the image memory 70 shown in FIG. 1 is inputted into a decoder 96, and one of the analogue switches 9411 to 9418 is brought into a conduction state by the output of the decoder 96 and outputs a gradation voltage according to the display data 95.

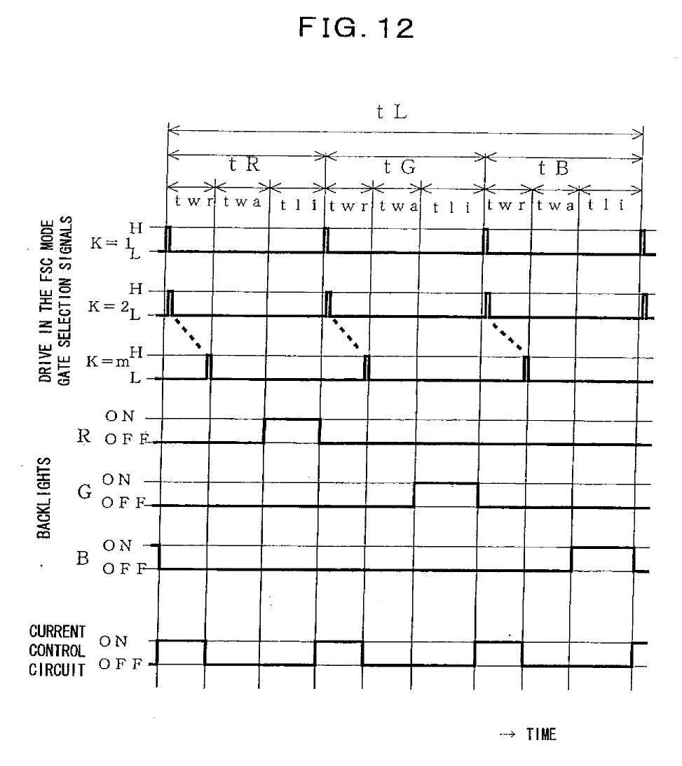

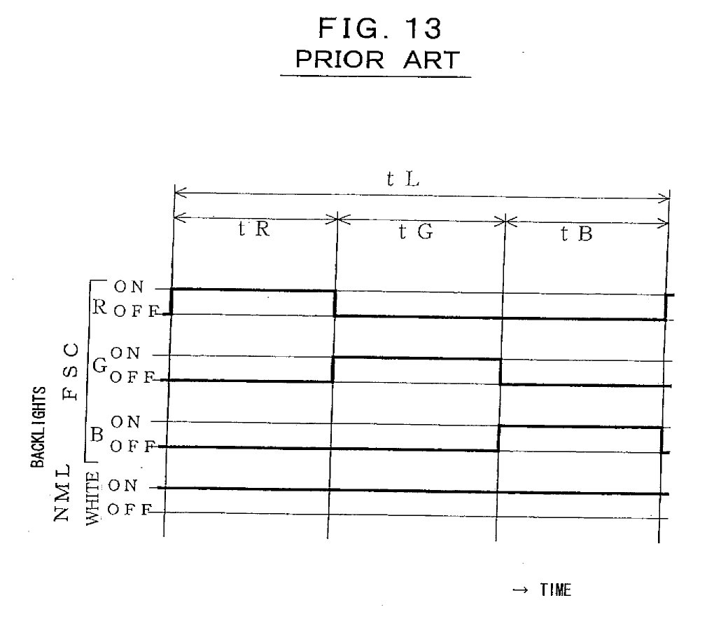

FIG. 12 is a timing chart for explaining a method of controlling the liquid crystal display device in the FSC mode according to the invention.

In FIG. 12, tL is one field period, and the one field period is divided into a red subfield tR, a green subfield tG, and a blue subfield tB. Further, each subfield is divided into a write period twr to write the display data into the liquid crystal display part, a response waiting period twa to wait for response by the liquid crystal display part, and a lighting period tli to permit the light source to emit light of that color as shown in the chart.

In the drive in the FSC mode, gate selection signals select m selection signal lines of the selection signal line group 50 shown in FIG. 7 in the liquid crystal display part 10 during the write period twr of the red subfield tR to write the display data for red into the liquid crystal display part 10.

A symbol “K” for the gate selection signal in FIG. 12 represents the line number.

For example, when the gate selection signal represented by K=1 is at H level, the signal selects the uppermost selection signal line 50l shown in FIG. 7, and when the gate selection signal represented by K=m is at H level, the signal selects the lowermost selection signal line 50m shown in FIG. 7, so that the display data is written into the capacitors 44 and 46 of each pixel region 43 shown in FIG. 7 of the liquid crystal display part during the period when the selection signal line is selected. After waiting for the response waiting period twa being the time of the liquid crystal responding to the display data, the red backlight “R” is turned on (ON) during the lighting period tli at the timing shown in FIG. 12.

In the similar manner, the gate selection signals select m selection signal lines during the write period twr of the green subfield tG to write the display data for green into the liquid crystal display part 10. After waiting for the response waiting period twa being the time of the liquid crystal responding to the display data, the green backlight “G” is then turned on (ON) during the lighting period tli at the timing shown in FIG. 12. Also in the blue subfield tB, the gate selection signals select m selection signal lines during the write period twr to write the display data for blue into the liquid crystal display part 10. After waiting for the response waiting period twa being the time of the liquid crystal responding to the display data, the blue backlight “B” is then turned on (ON) during the lighting period tli at the timing shown in FIG. 12.

The current control circuits I1 to I8 shown in FIG. 8 are controlled such that they are brought into a conduction state (ON) during the write period twr in each subfield to flow the bleeder current and brought into a non-conduction state (OFF) during the response waiting period twa and the lighting period tli in each field not to flow the bleeder current. The write period twr corresponds to the selection period, and the response waiting period twa and the lighting period tli correspond to the non-conduction period.

Such control can stabilize the voltages on the bus line 93 of gradation voltage on which the gradation voltages are being supplied in FIG. 8 during the write period twr to write the display data into each pixel of the liquid crystal display part, with the result that a deterioration in display quality due to crosstalk or the like can be prevented. Besides, during the response waiting period twa and the lighting period tli during which the display data is not written into each pixel of the liquid crystal display part but each pixel of the liquid crystal display part holds the display data, the bleeder current is not fed through the current control circuits I1 to I8, so that the low power consumption can be realized.

The example is illustrated in the above embodiment, in which the current control circuits I1 to I8 are turned ON only during the write period twr to flow current from of the source-follower connected transistors Tr1 to Tr8 shown in FIG. 8 to the current control circuits I1 to I8, and the current control circuits I1 to I8 are turned OFF during the response waiting period twa and the lighting period tli to interrupt the flow of current as described above. However, the period to flow the current to the current control circuits I1 to I8 may be extended into a portion of the response waiting period twa and the lighting period tli, or minute current may be fed, in place of turning OFF the current control circuits I1 to I8, in order to stabilize the voltage on the bus line 93 of gradation voltage.

In other words, the current fed through the current control circuits I1 to I8 during the write period twr set, for example, several ten times larger than that during most of the response waiting period twa and the lighting period tli brings about effects in maintaining the display quality and reducing the power consumption.

Further, this invention is not limited to the liquid crystal display device in the FSC mode, but is applicable, for example, both to a liquid crystal display device in an impulse driving mode in which the write period in one frame is made short, and a liquid crystal display device having a non-selection period during which data writing into the liquid crystal display device is stopped, such as a liquid crystal display device in a driving mode in which the flyback period after the gate selection period of TFT is long.

### INDUSTRIAL APPLICABILITY

As has been described, the number of elements constituting the gradation voltage generating circuit in the liquid crystal driving circuit and the area of the integrated circuit can be reduced according to the invention, resulting in significantly reduced power consumption and reduced cost. Further, by providing the current control circuit, a stable gradation voltage can be supplied to the liquid crystal display part to improve the display quality, so that a reduction in current can be realized with the display quality maintained.

Accordingly, the liquid crystal driving circuit and the liquid crystal display device according to the invention can be widely used in various kinds of portable electronic devices including cellular phone, portable digital assistant, portable liquid crystal television, mobile personal computer, and others.

1. A liquid crystal driving circuit for a liquid crystal display device including a liquid crystal display part having a transistor for each individual pixel; a group of selection signal lines each provided for each row of the liquid crystal display part and connected to a gate electrode of the transistor for selecting a row of the liquid crystal display part; and a group of data electrode lines each provided for each column of the liquid crystal display part and connected to a source electrode of the transistor for supplying voltage data for controlling a display state of each pixel of the liquid crystal display part,
wherein a gradation voltage generating circuit is provided for generating a plurality of voltages for gradation display by the liquid crystal part, the gradation voltage generating circuit including a gradation voltage generating part for generating a plurality of gradation voltages for gradation display by the pixels of the liquid crystal display part, a source-follower connected transistor group for performing impedance conversion on each of the plurality of gradation voltages, and an analogue switch part for selecting an output of the transistor group and applying the output to the data electrode line group.

2. The liquid crystal driving circuit according to claim 1,
wherein each transistor of the source-follower connected transistor group is provided with a current control circuit.

3. The liquid crystal driving circuit according to claim 2,
wherein the current control circuit includes a resistor element.

4. The liquid crystal driving circuit according to claim 2,
wherein the current control circuit includes at least a set of a resistor element and a switching element connected in series.

5. The liquid crystal driving circuit according to claim 2,
wherein a current to be fed through the current control circuit is made variable.

6. The liquid crystal driving circuit according to claim 5,
wherein the current to be fed through the current control circuit is set larger during a selection period to write data into the liquid crystal display device than during a non-selection period during which data writing into the liquid crystal display device is stopped.

7. The liquid crystal driving circuit according to claim 1,
wherein said circuit is a circuit for driving the liquid crystal display device including a light source for sequentially and repeatedly emitting a plurality of color light and a liquid crystal display part for controlling transmission of the light emitted by the light source, in which one field is divided into a plurality of sub-fields, specific color light of the plurality of color light is emitted during at least a portion of period of the plurality of sub-fields, and an image corresponding to the specific color light is displayed on the liquid crystal display part to perform color display.

8. A liquid crystal display device including a liquid crystal display part having a transistor for each individual pixel; a group of selection signal lines each provided for each row of the liquid crystal display part and connected to a gate electrode of the transistor for selecting a row of the liquid crystal display part; a group of data electrode lines each provided for each column of the liquid crystal display part and connected to a source electrode of the transistor for supplying voltage data for controlling a display state of each pixel of the liquid crystal display part; and a liquid crystal driving circuit for driving the liquid crystal display part,
wherein said liquid crystal driving circuit includes a gradation voltage generating circuit for generating a plurality of voltages for gradation display by the liquid crystal part,
the gradation voltage generating circuit having a gradation voltage generating part for generating a plurality of gradation voltages for gradation display by the pixels of the liquid crystal display part, a source-follower connected transistor group for performing impedance conversion on each of the plurality of gradation voltages, and an analogue switch part for selecting an output of the transistor group and applying the output to the data electrode line group.

9. The liquid crystal driving circuit according to claim 2,
wherein said circuit is a circuit for driving the liquid crystal display device including a light source for sequentially and repeatedly emitting a plurality of color light and a liquid crystal display part for controlling transmission of the light emitted by the light source, in which one field is divided into a plurality of sub-fields, specific color light of the plurality of color light is emitted during at least a portion of period of the plurality of sub-fields, and an image corresponding to the specific color light is displayed on the liquid crystal display part to perform color display.

10. The liquid crystal driving circuit according to claim 5,
wherein said circuit is a circuit for driving the liquid crystal display device including a light source for sequentially and repeatedly emitting a plurality of color light and a liquid crystal display part for controlling transmission of the light emitted by the light source, in which one field is divided into a plurality of sub-fields, specific color light of the plurality of color light is emitted during at least a portion of period of the plurality of sub-fields, and an image corresponding to the specific color light is displayed on the liquid crystal display part to perform color display.

11. The liquid crystal driving circuit according to claim 6,
wherein said circuit is a circuit for driving the liquid crystal display device including a light source for sequentially and repeatedly emitting a plurality of color light and a liquid crystal display part for controlling transmission of the light emitted by the light source, in which one field is divided into a plurality of sub-fields, specific color light of the plurality of color light is emitted during at least a portion of period of the plurality of sub-fields, and an image corresponding to the specific color light is displayed on the liquid crystal display part to perform color display.

12. The liquid crystal display device according to claim 8,
wherein each transistor of the source-follower connected transistor group is provided with a current control circuit.

13. The liquid crystal display device according to claim 12,
wherein a current to be fed through the current control circuit is made variable.

14. he liquid crystal display device according to claim 13,
wherein the current to be fed through the current control circuit is set larger during a selection period to write data into the liquid crystal display device than during a non-selection period during which data writing into the liquid crystal display device is stopped.

15. The liquid crystal display device according to claim 8,
wherein said liquid crystal driving circuit is a circuit for driving the liquid crystal display device including a light source for sequentially and repeatedly emitting a plurality of color light and a liquid crystal display part for controlling transmission of the light emitted by the light source, in which one field is divided into a plurality of sub-fields, specific color light of the plurality of color light is emitted during at least a portion of period of the plurality of sub-fields, and an image corresponding to the specific color light is displayed on the liquid crystal display part to perform color display.
